(19) United States
(12) Patent Application Publication
(10) Pub. No.: US 2009/0201297 A1
(43) Pub. Date: Aug. 13, 2009

(54) ELECTRONIC DEVICE WITH ANIMATED CHARACTER AND METHOD

(76) Inventor: Carolina S. M. Johansson, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/027,305

(22) Filed: Feb. 7, 2008

(51) Int. Cl. G06T 15/70

(52) U.S. Cl. 345/473

(57) ABSTRACT

An electronic device may display an animated character on a display and, when presence of a user is detected, the character may appear to react to the user. The character may be a representation of a person, an animal or other object. Ascertaining when the user is looking at the display may be accomplished by analyzing a video data stream generated by an imaging device, such as a camera used for video telephony.

### TECHNICAL FIELD OF THE INVENTION

The technology of the present disclosure relates generally to electronic devices and, more particularly, to an electronic device that displays a character on a display and, when presence of a user is detected, animates the character.

### BACKGROUND

Mobile electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Even with the various capabilities of many portable electronic devices, the user interfaces of these devices are rather dull. A user may be able to customize certain aspects of the user interface, such as by selecting a wallpaper for the background of the display or by selecting a color scheme for menus. But current customization techniques to enhance user interaction with portable electronic devices could still be improved.

### SUMMARY

To enhance a user's experience with a portable electronic device, the present disclosure describes an electronic device that displays a character on a display and, when presence of a user is detected, animates the character. The character may be a representation of a person, an animal or other object. The character may be in cartoon form (e.g., a hand drawn or computer generated graphic) or in the form of video of a live person, for example. In one embodiment, a picture of a person who is known to the user may be digitally merged with animated image data so that the character represents a person who is known to the user. As will be described, there may be other possibilities for the character. Animation of the character may be carried out when the user is looking at the display. Ascertaining when the user is looking at the display may be accomplished by applying face detection and/or facial recognition to a video data stream generated by an imaging device, such as a camera used for video telephony.

According to one aspect of the disclosure, an electronic device includes an imaging device that generates image data corresponding to a field of view of the imaging device; a display; and a control circuit that analyzes the image data to determine if a user is present in the field of view of the imaging device and, if so, controls the display to display an animated character.

According to one embodiment of the electronic device, the analyzing determines user presence using face detection.

According to one embodiment of the electronic device, the animated character is associated with a theme that is selected by the user.

According to one embodiment of the electronic device, the animated character is associated with appearance characteristics that are selected by the user.

According to one embodiment of the electronic device, an appearance of the animated character is based on a digital image of a person that is selected by the user.

According to one embodiment of the electronic device, if the user is not detected to be present in the field of view, the character is displayed in an idle mode.

According to one embodiment of the electronic device, animation of the character simulates a reaction to the user becoming present in the field of view by relative movement of the user and the electronic device.

According to one embodiment of the electronic device, the analyzing of the image data identifies movement or expression of the user and animation of the character simulates reaction to the movement or expression.

According to another aspect of the disclosure, a method of animating a user interface of an electronic device includes analyzing image data that is generated by an imaging device of the electronic device to determine if a user is present in a field of view of the imaging device; and if user presence is detected, controlling a display of the electronic device to display an animated character.

According to one embodiment of the method, the analyzing determines user presence using face detection.

According to one embodiment of the method, the animated character is associated with a theme that is selected by the user.

According to one embodiment of the method, the animated character is associated with appearance characteristics that are selected by the user.

According to one embodiment of the method, an appearance of the animated character is based on a digital image of a person that is selected by the user.

According to one embodiment of the method, if the user is not detected to be present in the field of view, the character is displayed in an idle mode.

According to one embodiment of the method, animation of the character simulates a reaction to the user becoming present in the field of view by relative movement of the user and the electronic device.

According to one embodiment of the method, the analyzing of the image data identifies movement or expression of the user and animation of the character simulates reaction to the movement or expression.

According to another aspect of the disclosure, a program is stored on a machine readable medium. The program controls animation of a user interface of an electronic device and includes executable logic to analyze image data that is generated by an imaging device of the electronic device to determine if a user is present in a field of view of the imaging device; and if user presence is detected, control a display of the electronic device to display an animated character.

According to one embodiment of the program, if the user is not detected to be present in the field of view, the character is displayed in an idle mode.

According to one embodiment of the program, animation of the character simulates a reaction to the user becoming present in the field of view by relative movement of the user and the electronic device.

According to one embodiment of the program, the analyzing of the image data identifies movement or expression of the user and animation of the character simulates reaction to the movement or expression.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic view of a mobile telephone as an exemplary electronic device that includes a user interface with an animated character;

FIG. 2 is a schematic block diagram of the electronic device of FIG. 1;

FIG. 3 is a flow chart representing an exemplary method of animating the animated character using the electronic device of FIG. 1;

FIG. 4 is a front view of a display of the electronic device with the animated character in an idle mode;

FIG. 5 is a front view of the display of the electronic device with the animated character in an animated mode; and

FIG. 6 is a schematic diagram of a communications system in which the electronic device may operate.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context of a mobile telephone. It will be appreciated, however, that the exemplary context of a mobile telephone is not the only operational environment in which aspects of the disclosed systems and methods may be used. Therefore, the techniques described in this document may be applied to any type of appropriate electronic device, examples of which include a mobile telephone, a media player, a gaming device, a computer, a pager, a communicator, an electronic organizer, a personal digital assistant (PDA), a smartphone, a portable communication apparatus, etc.

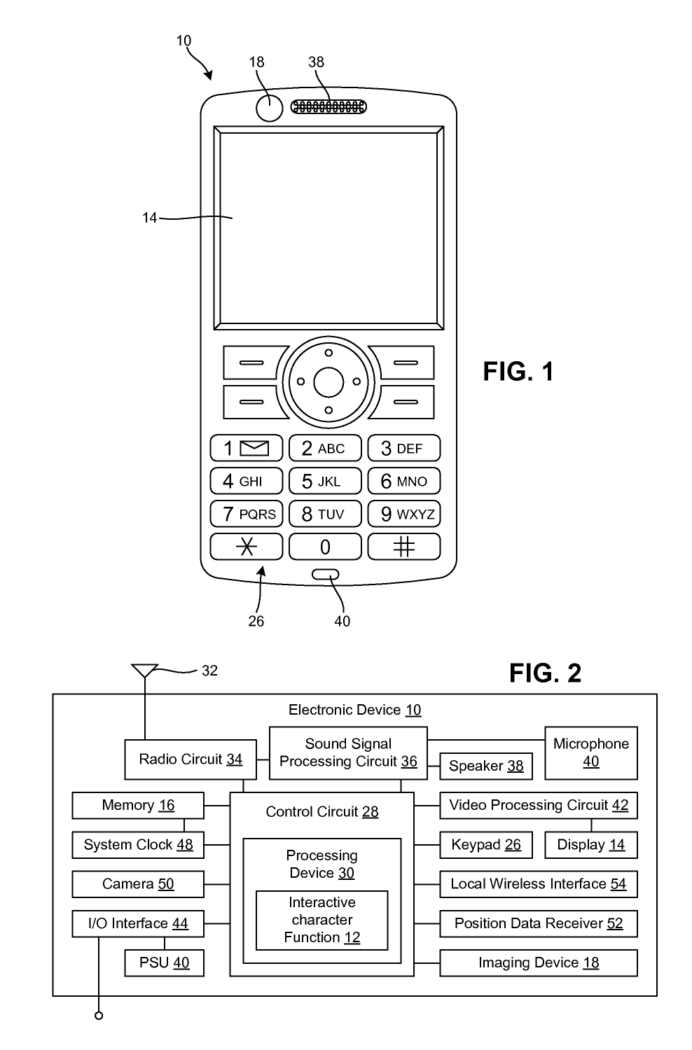

Referring initially to FIGS. 1 and 2, an electronic device 10 is shown. The electronic device 10 includes an interactive character function 12 that is configured to animate a displayed character to interact with a user of the electronic device 10. Additional details and operation of the interactive character function 12 will be described in greater detail below. The interactive character function 12 may be embodied as executable code that is resident in and executed by the electronic device 10. In one embodiment, the interactive character function 12 may be a program stored on a computer or machine readable medium. The interactive character function 12 may be a stand-alone software application or form a part of a software application that carries out additional tasks related to the electronic device 10.

The electronic device 10 may include a display 14. The display 14 displays information to a user such as operating state, time, telephone numbers, contact information, various menus, etc., that enable the user to utilize the various features of the electronic device 10. The display 14 also may be used to visually display content received by the electronic device 10 and/or retrieved from a memory 16 (FIG. 2) of the electronic device 10. The display 14 may be used to present images, video and other graphics to the user, such as photographs, mobile television content and video associated with games.

In addition, and as will be described in detail below, the display 14 may display an interactive animated character. At times, the character may be animated to give the appearance that the character is moving and is being responsive to a user of the electronic device 10. To detect the presence of the user to determine when to animate the character, and sometimes how to animate the character, the electronic device 10 may include a sensor, such as an imaging device 18. The image device 10 may output image data at a predetermined frame rate so as to generate a video signal. In the illustrated embodiment, the imaging device 18 is a video phone camera that is directed toward the user when the user is positioned in front of the display 14. In this arrangement, the video signal from the image device 18 may be used for carrying out video telephone calls, sometimes referred to as video telephony. It will be appreciated that other types of sensors or imaging devices may be employed to detect the user.

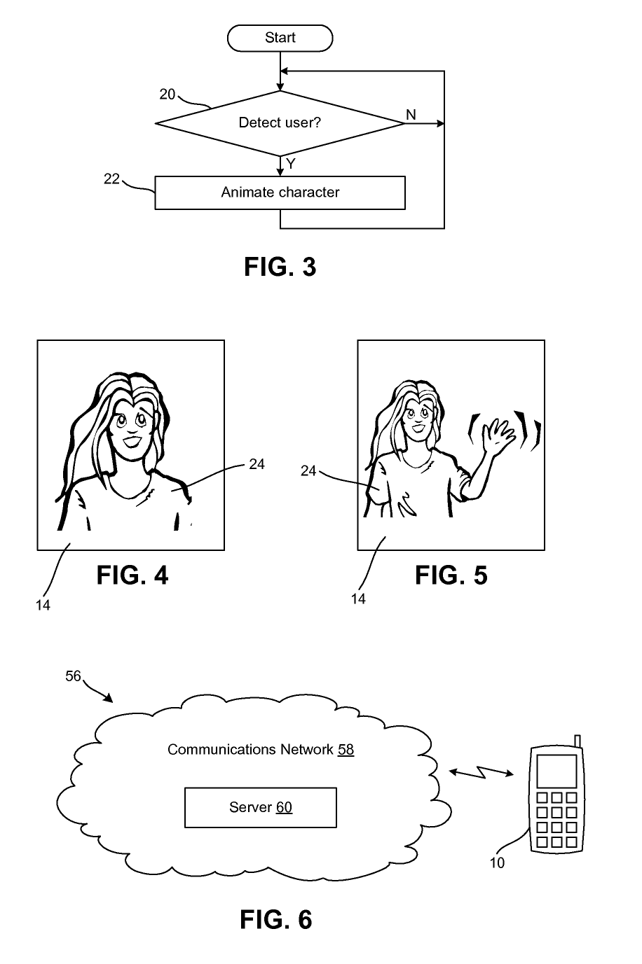

With additional reference to FIG. 3, illustrated are logical operations to implement an exemplary method of interactively animating a displayed character. The exemplary method may be carried out by executing an embodiment of the interactive character function 12, for example. Thus, the flow chart of FIG. 3 may be thought of as depicting steps of a method carried out by the electronic device 10. Although FIG. 3 shows a specific order of executing functional logic blocks, the method may be modified from the illustrated embodiment.

The logical flow for the interactive character function 12 may begin in block 20 where a determination may be made as to whether the user is looking at the display 14. In one embodiment, the determination may be made by analyzing the image data from the imaging device 18. The analyzing may be conducted continuously or on a periodic basis. Also, the analyzing may be carried out only during certain operational modes of the electronic device 10. The analysis of the image data may include conducting face detection. In one embodiment, if a face is detected, it may be concluded that the user is positioned in front of the display 14 with a relatively high probability that the user is looking at the display 14. If a face is detected, a positive determination may be made in block 20 and, if a face is not detected, a negative determination may be made in block 20. In some embodiments, the determination of block 20 may include conducting facial recognition to attempt to determine an identity of a detected user. If a negative determination is made in block 20, the logical flow may wait until a user is detected.

With additional reference to FIG. 4, a character 24 may be displayed on the display 14. The character 24 may be a representation of a person, an animal (e.g., a dog or a cat), or an object (e.g., a car, a boat, the moon, the sun, etc.). In one embodiment, multiple characters may be present. The character 24 may be in the form of a cartoon character, such as a hand drawn character that is digitized for presentation on the display 14 and/or a computer generated graphical character. In other embodiments, the character 24 may be in the form of a real person, animal or object, in which case still images and/or video clips of an actor, animal or object may be used to generate the displayed character 24. In another embodiment, a digital image may be merged with previously generated image and/or video data to generate the character 24. For instance, a digital image of a face may be digitally stitched into image and/or video data so that the character 24 is personalized. The image may be selected by the user so that the character 24 may represent a person of the user's choosing, such as a family member, a friend, a celebrity, etc.

The character may be associated with a theme, especially for characters that represent a person or a cartoon figure. In some embodiments, the theme may be selected by the user. Exemplary themes for a person or other character with a human likeness include, but are not limited to, a cute baby, a scary person or monster (e.g., a villain from a horror movie), an attractive man, an attractive woman, an ethnic or historical character (e.g., a Viking, a Native American, an ancient Roman or an ancient Egyptian), a celebrity, an athlete, and so on. Additional characteristics regarding the appearance character 24 may be selected by the user, such as the character's race, the character's gender, the character's age, the character's body type (e.g., heavy or slim), the character's facial features, the character's hair style and/or color, etc. In other embodiments, the character 24 may be based on a default setting or may be automatically changed so that the user is exposed to multiple characters over the course of time.

At times, the character 24 may be made to move. To give the appearance that the character 24 is moving, the character 24 may be associated with a database of video files. Each video file may be associated with a different action. For example, if the character represents a person, the actions may include waving, pretending to hide (e.g., peer at the user from the side of that display 14 and then move from view), jumping around, dancing, fighting, cheering, flirting, winking, pretending to ignore the user (e.g., turn away from the user), pointing, talking, singing, laughing, and any other action that a person might carry out. The video files may be generated in a variety of manners, including filming video clips, generating animations, and/or using computer graphics (e.g., automated processing used in the creation of visual effects for movies).

In FIG. 4, the character 24 is in an idle mode. The idle mode may be used when no user has been detected in block 20 and the electronic device 10 is waiting to make a positive determination. In the idle mode, the character 24 may appear as stationary, such as would be the case if the character where posed in a digital picture or in a painting. Alternatively, in the idle mode, the character 24 may move. For instance, the character 24 may appear as being impatient, such as pacing or standing while tapping a foot. As another example, the character 24 may appear to be sleeping.

With continued reference to the flow diagram of FIG. 3 and with additional reference to FIG. 5, if a positive determination is made in block 20, the logical flow may proceed to block 22. In block 22, the character 24 may be made to move (e.g., become animated) to give the appearance that the character 24 is interacting with the user. For example, upon detection of the user in block 20, the character 24 may wave to the user as shown in the exemplary illustration of FIG. 5. The movement may be based on a video file from a database of video files. If the character 24 is associated with a theme, the actions of the animation of the character 24 may be coordinated with the theme. In embodiments where there are multiple possible animations for the character 24, the animation may be selected based on one or more factors, selected at random, or selected based on a predetermined sequence. Factors for selecting an animation may include, for example, operational mode of the electronic device 10, the amount of time since the last detection of the user, the frequency with which each animation is used, the identity of the user (if determined), the time of day, the day of the week, the season, the weather as ascertained from a weather reporting service, the location of the electronic device 10, the detection of multiple faces in block 20, and so forth. The animation also may be selected based on information about the user that this extracted from the video signal from the imaging device 18. For instance, if the user is found to be moving (e.g., nodding, shaking his or her head, waving a hand, speaking, etc.) the animation may be selected to have relevance to the movement of the user. In addition, with sophisticated face detection or facial recognition processing, it may be possible to detect a facial expression of the user and the animation may be selected based on a detected facial expression.

In one embodiment, audio may be associated with the character 24 and/or made part of some of the animations. For instance, the character 24 may be animated to appear to speak or sing along with a corresponding audio component. Also background music may be played in connection with the animation of the character 24. In one embodiment, the audio may follow a script that is associated with the animation and custom words may be inserted into the script. In this manner, the audio may include use of the user's name, for example. Also, the animation and/or the script may be driven based on information stored in a contact list and/or a calendar. Using this information, the character 24 may be animated to wish the user a happy birthday on the appropriate day of the year, announce meetings, remind the user of occasions (e.g., other people's birthdays and anniversaries, etc.), announce incoming calls or messages, etc.

In one embodiment, the video data and/or audio associated with the character 24 may be generated by and/or maintained by a centralized server. In this manner, a relatively large database of animations for a variety of character themes may be maintained. Also, processing to generate animations for a specific character that is selected by the user may be carried out by the server to conserve processing resources of the electronic device 10. To speed the display of specific animations, video data and/or audio data corresponding to the specific character that is displayed by the electronic device 10 may be transferred from the server to the electronic device 10 for local storage, such as in the memory 16.

At least some of the animations may be arranged so that the user feels as if the character 24 observes that the user has come into position in front of the display 14 and the character 24 reacts to the arrival of the user in this position in a welcoming manner. This type of animation, which may be driven by the detection of the user's face, may impart an interactive quality to the user's experience with the electronic device 10. As a result, the electronic device 10 may be personalized to the user and/or the user may feel as if he or she has a “friendly connection” (e.g., a relationship) with the character 24.

With renewed reference to FIGS. 1 and 2, additional aspects of the electronic device 10 when implemented as a mobile telephone will be described. The electronic device 10 is shown as having a “brick” or “block” form factor housing, but it will be appreciated that other housing types may be utilized, such as a “flip-open” form factor (e.g., a “clamshell” housing), a slide-type form factor (e.g., a “slider” housing) and/or a pivoting form factor.

A keypad 26 provides for a variety of user input operations. For example, the keypad 26 may include alphanumeric keys for allowing entry of alphanumeric information such as telephone numbers, phone lists, contact information, notes, text, etc. In addition, the keypad 26 may include special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 26 may be used in conjunction with one another to implement soft key functionality.

The electronic device 10 includes call circuitry that enables the electronic device 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 10 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 16, executing applications to allow user interaction with the data, displaying video and/or image content associated with the data, outputting audio sounds associated with the data, and so forth.

The electronic device 10 may include a primary control circuit 28 that is configured to carry out overall control of the functions and operations of the electronic device 10. The control circuit 28 may include a processing device 30, such as a central processing unit (CPU), microcontroller or microprocessor. The processing device 30 executes code stored in a memory (not shown) within the control circuit 28 and/or in a separate memory, such as the memory 16, in order to carry out operation of the electronic device 10. The processing device 30 may execute code that implements the interactive character function 12. It will be apparent to a person having ordinary skill in the art of computer programming, and specifically in application programming for mobile telephones or other electronic devices, how to program a electronic device 10 to operate and carry out logical functions associated with the interactive character function 12. Accordingly, details as to specific programming code have been left out for the sake of brevity. Also, while the interactive character function 12 is executed by the processing device 30 in accordance with an embodiment, such functionality could also be carried out via dedicated hardware or firmware, or some combination of hardware, firmware and/or software.

The memory 16 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory (e.g., a NAND or NOR architecture flash memory) for long term data storage and a volatile memory that functions as system memory for the control circuit 28. The volatile memory may be a RAM implemented with synchronous dynamic random access memory (SDRAM), for example. The memory 16 may exchange data with the control circuit 28 over a data bus. Accompanying control lines and an address bus between the memory 16 and the control circuit 28 also may be present.

Continuing to refer to FIGS. 1 and 2, the electronic device 10 includes an antenna 32 coupled to a radio circuit 34. The radio circuit 34 includes a radio frequency transmitter and receiver for transmitting and receiving signals via the antenna 32. The radio circuit 34 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 32 and the radio circuit 34 may represent one or more than one radio transceiver.

The electronic device 10 further includes a sound signal processing circuit 36 for processing audio signals transmitted by and received from the radio circuit 34. Coupled to the sound processing circuit 36 are a speaker 38 and a microphone 40 that enable a user to listen and speak via the electronic device 10. The radio circuit 34 and sound processing circuit 36 are each coupled to the control circuit 28 so as to carry out overall operation. Audio data may be passed from the control circuit 28 to the sound signal processing circuit 36 for playback to the user. The audio data may include, for example, audio data from an audio file stored by the memory 16 and retrieved by the control circuit 28, or received audio data such as in the form of streaming audio data from a mobile radio service. The sound processing circuit 36 may include any appropriate buffers, decoders, amplifiers and so forth.

The display 14 may be coupled to the control circuit 28 by a video processing circuit 42 that converts video data to a video signal used to drive the display 14. The video processing circuit 42 may include any appropriate buffers, decoders, video data processors and so forth. The video data may be generated by the control circuit 28, retrieved from a video file that is stored in the memory 16, derived from an incoming video data stream that is received by the radio circuit 34 or obtained by any other suitable method.

The electronic device 10 may further include one or more input/output (I/O) interface(s) 44. The I/O interface(s) 44 may be in the form of typical mobile telephone I/O interfaces and may include one or more electrical connectors. As is typical, the I/O interface(s) 44 may be used to couple the electronic device 10 to a battery charger to charge a battery of a power supply unit (PSU) 46 within the electronic device 10. In addition, or in the alternative, the I/O interface(s) 44 may serve to connect the electronic device 10 to a headset assembly (e.g., a personal handsfree (PHF) device) that has a wired interface with the electronic device 10. Further, the I/O interface(s) 44 may serve to connect the electronic device 10 to a personal computer or other device via a data cable for the exchange of data. The electronic device 10 may receive operating power via the I/O interface(s) 44 when connected to a vehicle power adapter or an electricity outlet power adapter. The PSU 46 may supply power to operate the electronic device 10 in the absence of an external power source.

The electronic device 10 also may include a system clock 48 for clocking the various components of the electronic device 10, such as the control circuit 28 and the memory 16.

In addition to the imaging device 18, the electronic device 10 may include a camera 50 for taking digital pictures and/or movies. Image and/or video files corresponding to the pictures and/or movies may be stored in the memory 16.

The electronic device 10 also may include a position data receiver 52, such as a global positioning system (GPS) receiver, Galileo satellite system receiver or the like. The position data receiver 52 may be involved in determining the location of the electronic device 10.

The electronic device 10 also may include a local wireless interface 54, such as an infrared transceiver and/or an RF interface (e.g., a Bluetooth interface), for establishing communication with an accessory, another mobile radio terminal, a computer or another device. For example, the local wireless interface 54 may operatively couple the electronic device 10 to a headset assembly (e.g., a PHF device) in an embodiment where the headset assembly has a corresponding wireless interface.

With additional reference to FIG. 6, the electronic device 10 may be configured to operate as part of a communications system 56. The system 56 may include a communications network 58 having a server 60 (or servers) for managing calls placed by and destined to the electronic device 10, transmitting data to the electronic device 10 and carrying out any other support functions. The server 60 communicates with the electronic device 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 58 may support the communications activity of multiple electronic devices 10 and other types of end user devices. As will be appreciated, the server 60 may be configured as a typical computer system used to carry out server functions and may include a processor configured to execute software containing logical instructions that embody the functions of the server 60 and a memory to store such software.

Although certain embodiments have been shown and described, it is understood that equivalents and modifications falling within the scope of the appended claims will occur to others who are skilled in the art upon the reading and understanding of this specification.

What is claimed is:

1. An electronic device, comprising:
an imaging device that generates image data corresponding to a field of view of the imaging device;
a display; and
a control circuit that analyzes the image data to determine if a user is present in the field of view of the imaging device and, if so, controls the display to display an animated character.

2. The electronic device of claim 1, wherein the analyzing determines user presence using face detection.

3. The electronic device of claim 1, wherein the animated character is associated with a theme that is selected by the user.

4. The electronic device of claim 1, wherein the animated character is associated with appearance characteristics that are selected by the user.

5. The electronic device of claim 1, wherein an appearance of the animated character is based on a digital image of a person that is selected by the user.

6. The electronic device of claim 1, wherein if the user is not detected to be present in the field of view, the character is displayed in an idle mode.

7. The electronic device of claim 1, wherein animation of the character simulates a reaction to the user becoming present in the field of view by relative movement of the user and the electronic device.

8. The electronic device of claim 1, wherein the analyzing of the image data identifies movement or expression of the user and animation of the character simulates reaction to the movement or expression.

9. A method of animating a user interface of an electronic device, comprising:
analyzing image data that is generated by an imaging device of the electronic device to determine if a user is present in a field of view of the imaging device; and
if user presence is detected, controlling a display of the electronic device to display an animated character.

10. The method of claim 9, wherein the analyzing determines user presence using face detection.

11. The method of claim 9, wherein the animated character is associated with a theme that is selected by the user.

12. The method of claim 9, wherein the animated character is associated with appearance characteristics that are selected by the user.

13. The method of claim 9, wherein an appearance of the animated character is based on a digital image of a person that is selected by the user.

14. The method of claim 9, wherein if the user is not detected to be present in the field of view, the character is displayed in an idle mode.

15. The method of claim 9, wherein animation of the character simulates a reaction to the user becoming present in the field of view by relative movement of the user and the electronic device.

16. The method of claim 9, wherein the analyzing of the image data identifies movement or expression of the user and animation of the character simulates reaction to the movement or expression.

17. A program stored on a machine readable medium, the program for animating a user interface of an electronic device and comprising executable logic to:
analyze image data that is generated by an imaging device of the electronic device to determine if a user is present in a field of view of the imaging device; and
if user presence is detected, control a display of the electronic device to display an animated character.

18. The program of claim 17, wherein if the user is not detected to be present in the field of view, the character is displayed in an idle mode.

19. The program of claim 17, wherein animation of the character simulates a reaction to the user becoming present in the field of view by relative movement of the user and the electronic device.

20. The program of claim 17, wherein the analyzing of the image data identifies movement or expression of the user and animation of the character simulates reaction to the movement or expression.
